(19) United States
(12) Patent Application Publication
(10) Pub. No.: US 2024/0010762 A1
(43) Pub. Date: Jan. 11, 2024

(54) MANUFACTURING METHOD AND USE FOR CHLORINATED POLYVINYL CHLORIDE RESIN

(71) Applicant: KANEKA CORPORATION, Osaka (JP)

(72) Inventors: Kazuhiro Matsuo, Hyogo (JP); Katsuyuki Tanaka, Hyogo (JP)

(73) Assignee: KANEKA CORPORATION, Osaka (JP)

(21) Appl. No.: 18/371,679

(22) Filed: Sep. 22, 2023

Related U.S. Application Data
(63) Continuation of application No. PCT/JP2022/013069, filed on Mar. 22, 2022.

(30) Foreign Application Priority Data
Mar. 24, 2021 (JP) 2021-050634

(51) Int. Cl. C08F 8/22; C08L 27/24

(52) U.S. Cl. CPC C08F 8/22; C08L 27/24

(57) ABSTRACT

A chlorinated polyvinyl chloride-based resin that is excellent in processability, thermal stability, and physical properties is provided. A method for producing the chlorinated polyvinyl chloride-based resin includes a chlorination step of supplying chlorine to slurry containing a polyvinyl chloride-based resin and powder of a polypropylene-based resin that has a viscosity average molecular weight of not less than 3,500, and irradiating the slurry with ultraviolet light to thereby chlorinate the polyvinyl chloride-based resin.

### TECHNICAL FIELD

One or more embodiments of the present invention relate to a method for producing a chlorinated polyvinyl chloride-based resin and use thereof.

### BACKGROUND

Chlorinated polyvinyl chloride-based resins, which are obtained by chlorination of a polyvinyl chloride-based resin, are known to have improved thermal stability (e.g., heat resistance and flame retardancy) while retaining advantages (e.g., chemical resistance, solvent resistance, and water resistance) of the polyvinyl chloride-based resin. Further, chlorinated polyvinyl chloride-based resins can be used in various applications by changing a polymerization degree and a chlorination degree.

Chlorinated polyvinyl chloride-based resins can be used even in various applications in which a polyvinyl chloride-based resin cannot be used, such as a heat-resistant pipe, a heat-resistant joint, a heat-resistant valve, and a heat-resistant sheet.

For example, Patent Literature 1 discloses a chlorinated polyvinyl chloride-based resin composition containing not less than 0.1 parts by weight and not more than 3 parts by weight of a chlorinated polypropylene-based resin, a thermal stabilizer, an impact absorbing agent (impact resistance improving agent), and a lubricant, relative to 100 parts by weight of a chlorinated polyvinyl chloride-based resin.

Patent Literature 2 discloses a vinyl chloride polymer composition containing: a vinyl chloride polymer resin having a repeating unit into which a vinyl chloride monomer is polymerized; a block chlorinated polyolefin having a residual block of a crystalline polyolefin; and an impact modifier.

Patent Literature 3 discloses a method for producing a chlorinated polyvinyl chloride-based resin in which, in a state where powder of a propylene polymer having a viscosity average molecular weight of not more than 10,000 and a vinyl chloride monomer are dispersed in a solvent, the vinyl chloride monomer is polymerized, and a polyvinyl chloride-based resin is chlorinated.

### PATENT LITERATURE

### Patent Literature 1

Japanese Patent Application Publication Tokukai No. 2001-131374

### Patent Literature 2

Published Japanese Translation of PCT International Application Tokuhyo No. 2003-510438

### Patent Literature 3

Japanese Patent Application Publication Tokukaihei No. 2-242841

However, in order to improve processability, thermal stability, and physical properties of a resin composition (a chlorinated polyvinyl chloride-based resin composition) of a chlorinated polyvinyl chloride-based resin obtained by each of the above-described known techniques, it is necessary to add a large amount of an additive such as a lubricant, a thermal stabilizer, and an impact absorbing agent. Thus, the above-described known techniques still have some room for improvement.

### SUMMARY

An aspect of one or more embodiments of the present invention provide a chlorinated polyvinyl chloride-based resin for obtaining a chlorinated polyvinyl chloride-based resin composition that is excellent in processability, thermal stability, and physical properties, the chlorinated polyvinyl chloride-based resin not requiring addition of a large amount of an additive when the resin composition is produced from the chlorinated polyvinyl chloride-based resin.

One or more embodiments of the present invention include the following.

A method for producing a chlorinated polyvinyl chloride-based resin, including a chlorination step of (i) supplying chlorine to slurry containing a polyvinyl chloride-based resin and powder of a polypropylene-based resin that has a viscosity average molecular weight of not less than 3,500 and (ii) irradiating the slurry with ultraviolet light to thereby chlorinate the polyvinyl chloride-based resin.

An aspect of one or more embodiments of the present invention makes it possible to provide a chlorinated polyvinyl chloride-based resin for obtaining, without addition of a large amount of an additive, a chlorinated polyvinyl chloride-based resin composition that is excellent in processability, thermal stability, and physical properties.

### DETAILED DESCRIPTION

<Method for Producing Chlorinated Polyvinyl Chloride-Based Resin>

The following description will discuss in detail a method for producing a chlorinated polyvinyl chloride-based resin in accordance with one or more embodiments of the present invention.

The method for producing a chlorinated polyvinyl chloride-based resin in accordance with one or more embodiments includes a chlorination step, and may further include water rinsing and drying steps after the chlorination step.

[Chlorination Step]

In the chlorination step, chlorine is supplied to slurry containing a polyvinyl chloride-based resin and powder of a polypropylene-based resin that has a viscosity average molecular weight of not less than 3,500, and the slurry is irradiated with ultraviolet light, so that the polyvinyl chloride-based resin is chlorinated.

Note here that chlorinated polyvinyl chloride-based resins typically have an increased amount of chlorine atoms, which constitute a polar group, and therefore generate an increased amount of shear heat during processing. Further, in order to obtain a chlorinated polyvinyl chloride-based resin composition having good physical properties, a high processing temperature is required. Furthermore, chlorinated polyvinyl chloride-based resins have a decomposition temperature similar, or substantially identical, to that of polyvinyl chloride-based resins and thus are not superior to polyvinyl chloride-based resins in terms of processability.

As such, conventional chlorinated polyvinyl chloride-based resins usually require addition of a large amount of an additive such as a lubricant, a thermal stabilizer, and an impact absorbing agent in order to improve processability, and thus require a high production cost for obtaining a chlorinated polyvinyl chloride-based resin composition. Further, as a result of study by the inventors of one or more embodiments of the present invention, it was also found that adding an additive such as a lubricant in a large amount may reduce physical properties in exchange for gaining improved processability, and achieving both processability and physical properties of the chlorinated polyvinyl chloride-based resin composition was therefore difficult.

In light of this, the inventors of one or more embodiments of the present invention made diligent study and has found that, by adding powder of a polypropylene-based resin having a viscosity average molecular weight of not less than 3,500 to slurry of a polyvinyl chloride-based resin in advance and then irradiating the slurry with ultraviolet light to thereby cause chlorination, it is possible to produce a chlorinated polyvinyl chloride-based resin for obtaining, without addition of a large amount of an additive, a chlorinated polyvinyl chloride-based resin composition that is excellent in processability, thermal stability, and physical properties.

This is considered to be because causing the polypropylene-based resin to be dispersed in advance, in the form of powder, in the slurry containing the polyvinyl chloride-based resin allows the polyvinyl chloride-based resin to be chlorinated in a state where the polypropylene-based resin is uniformly dispersed in the slurry containing the polyvinyl chloride-based resin. That is, in this case, it is possible to obtain a resin composition in which the (chlorinated) polypropylene-based resin and the chlorinated polyvinyl chloride-based resin are mixed more uniformly as compared with a case in which powder of the polypropylene-based resin is separately added after chlorination of the polyvinyl chloride-based resin.

The chlorination step includes a raw material supply step, a chlorine supply step, and an ultraviolet irradiation step, and may further include a stirring step between the raw material supply step and the chlorine supply step.

The polyvinyl chloride-based resin, the powder of the polypropylene-based resin having a viscosity average molecular weight of not less than 3,500, the slurry, and the chlorinated polyvinyl chloride-based resin will be described in details later in descriptions of the raw material supply step and the ultraviolet irradiation step.

[Raw Material Supply Step]

In the raw material supply step, a solvent, a polyvinyl chloride-based resin, powder of a polypropylene-based resin having a viscosity average molecular weight of not less than 3,500, and, as needed, a dispersing agent are supplied to the reactor to obtain slurry.

(Slurry)

In the slurry, a resin containing the polyvinyl chloride-based resin and the powder of the polypropylene-based resin having a viscosity average molecular weight of not less than 3,500 is dispersed in the solvent.

Examples of the solvent include an aqueous solvent and a solvent obtained by adding a water-insoluble organic solvent to water.

The aqueous solvent is not limited to water, and can be, for example, an aqueous solvent obtained by adding to water an organic solvent that can be mixed with water, such as methyl alcohol or ethyl alcohol.

Examples of the water-insoluble organic solvent include chloroform, halogenated hydrocarbons, halogenated hydrocarbons, aromatic hydrocarbons, and ethers. Examples of the halogenated hydrocarbons include carbon tetrachloride. Examples of the halogenated hydrocarbons include benzene and toluene. Examples of the aromatic hydrocarbon include benzene and toluene. Examples of the ethers include methyl ethyl ketone and methyl isobutyl ketone.

The slurry may contain a dispersing agent. In a case where the slurry contains the dispersing agent, the polyvinyl chloride-based resin and the powder of the polypropylene-based resin can be suitably dispersed in the solvent.

The dispersing agent is not limited to any particular one, provided that the dispersing agent is capable of causing the polyvinyl chloride-based resin and the powder of the polypropylene-based resin to be dispersed in the solvent. Examples of the dispersing agent include a cellulose derivative.

Examples of the cellulose derivative include cellulose ethers. Examples of the cellulose ethers include methyl cellulose, ethyl cellulose, hydroxy methyl cellulose, and hydroxy propyl cellulose.

(Polyvinyl Chloride-Based Resin)

The polyvinyl chloride-based resin is a polymer of a vinyl chloride-based resin.

Examples of the polyvinyl chloride-based resin include: polyvinyl chloride (PVC), which is a homopolymer of vinyl chloride; a copolymer of a vinyl chloride unit and another monomer unit copolymerizable with vinyl chloride; and a graft polymer obtained by subjecting a vinyl chloride monomer to graft polymerization.

Examples of the another monomer copolymerizable with vinyl chloride include, but are not particularly limited to, α-olefins, vinyl esters, vinyl ethers, acrylate, methacrylates, N-substituted maleimides, allyl chloride, vinylidene chloride, an allylglycidyl ether, and an acrylic acid ester.

Examples of the α-olefins include ethylene and propylene. Examples of the vinyl esters include vinyl acetate. Examples of the vinyl ethers include cetyl vinyl ether. Examples of the acrylate include 2-ethylhexyl acrylate and butyl methacrylate. Examples of the N-substituted maleimides include phenylmaleimide and cyclohexylmaleimide.

Examples of the graft polymer produced by subjecting a vinyl chloride monomer to graft polymerization include a graft polymer between a polymer such as an ethylene-vinyl acetate copolymer and a vinyl chloride monomer.

The polyvinyl chloride-based resin may have a K value (polymerization degree) of not less than 45 and not more than 89, not less than 49 and not more than 77, or not less than 50 and not more than 72. In a case where the polyvinyl chloride-based resin has a K value of not less than 45 and not more than 89, it is possible to produce a chlorinated polyvinyl chloride-based resin for obtaining a chlorinated polyvinyl chloride-based resin composition that is more excellent in processability and physical properties. Note that the K value is obtained in accordance with JIS K7367-2.

The polyvinyl chloride-based resin may have an apparent density of not less than 0.400 g/mL and not more than 0.700 g/mL, or not less than 0.450 g/mL and not more than 0.670 g/mL. In a case where the polyvinyl chloride-based resin has an apparent density of not less than 0.400 g/mL and not more than g/mL, it is possible to produce a chlorinated polyvinyl chloride-based resin for obtaining a chlorinated polyvinyl chloride-based resin composition that is more excellent in processability and physical properties. Note that the apparent density is a value measured in accordance with JIS K7365.

The polyvinyl chloride-based resin may have an average particle size of not less than 50 μm and not more than 500 μm, not less than 50 μm and not more than 200 μm, or not less than 100 μm and not more than 200 μm. In a case where the polyvinyl chloride-based resin has an average particle size of not less than 50 μm and not more than 500 μm, it is possible to produce a chlorinated polyvinyl chloride-based resin for obtaining a chlorinated polyvinyl chloride-based resin composition that is more excellent in processability and physical properties. Note that the “average particle size” described here is a value indicating a particle size at which a cumulative value reaches 50% in measurement of a particle diameter distribution in accordance with JIS K0069.

A content of the polyvinyl chloride-based resin in the slurry may be not less than 10% by weight and not more than 40% by weight, or not less than 10% by weight and not more than 31% by weight. In a case where the content of the polyvinyl chloride-based resin in the slurry is not less than 10% by weight and not more than 40% by weight, it is possible to chlorinate the polyvinyl chloride-based resin more suitably.

(Polypropylene-Based Resin)

The polypropylene-based resin is a polymer of propylene.

Examples of the polypropylene-based resin include polypropylene (PP), which is a homopolymer of propylene, and a copolymer of a propylene unit and another monomer unit copolymerizable with polypropylene. Use of the polypropylene-based resin makes it possible to produce a chlorinated polyvinyl chloride-based resin for obtaining a chlorinated polyvinyl chloride-based resin composition that is more excellent in processability and physical properties.

The another monomer to be copolymerized with propylene is not limited to any particular one. Examples the another monomer include: ethylene; and a monomer including a hydroxyl group, a carboxyl group, a ketone group, an epoxy group, and the like.

A lower limit value of a viscosity average molecular weight of the polypropylene-based resin only needs to be, for example, not less than 3,500, and may be not less than 4,000, not less than 5,000, not less than 7,000, or not less than 10,000. An upper limit value of the viscosity average molecular weight of the polypropylene-based resin may be not more than 30,000, not more than 25,000 or not more than 21,000.

In a case where the viscosity average molecular weight of the polypropylene-based resin has a lower limit value of not less than 3,500, it is possible to produce a chlorinated polyvinyl chloride-based resin for obtaining a chlorinated polyvinyl chloride-based resin composition that is more excellent in processability, thermal stability, and physical properties. In a case where the viscosity average molecular weight of the polypropylene-based resin has a lower limit value of not less than 4,000, it is possible to produce a chlorinated polyvinyl chloride-based resin for obtaining a chlorinated polyvinyl chloride-based resin composition even more excellent in processability, thermal stability, and physical properties. In particular, it is possible to produce a chlorinated polyvinyl chloride-based resin for obtaining a chlorinated polyvinyl chloride-based resin composition excellent in processability and physical properties.

Likewise, in a case where the viscosity average molecular weight of the polypropylene-based resin has an upper limit value of not more than 30,000, it is possible to produce a chlorinated polyvinyl chloride-based resin for obtaining a chlorinated polyvinyl chloride-based resin composition more excellent in processability, thermal stability, and physical properties. In a case where the viscosity average molecular weight of the polypropylene-based resin has an upper limit value of not more than 25,000, it is possible to produce a chlorinated polyvinyl chloride-based resin for obtaining a chlorinated polyvinyl chloride-based resin composition that is even more excellent in processability, thermal stability, and physical properties, particularly in physical properties.

The polypropylene-based resin may have a melting point of, for example, not lower than 100° C. and not higher than 170° C., not lower than 105° C. and not higher than 168° C., or not lower than 110° C. and not higher than 165° C. In a case where the polypropylene-based resin has a melting point of not lower than 100° C. and not higher than 170° C., it is possible to produce a chlorinated polyvinyl chloride-based resin for obtaining a chlorinated polyvinyl chloride-based resin composition that is more excellent in processability and physical properties.

Measurement of a melting point of the polypropylene-based resin was carried out with the following device and under the following conditions.
Device: differential scanning calorimeter DSC7020 (manufactured by Hitachi High-Tech Science Corporation):
Sample container: AI open-type sample container with φ of 5.2 and H of 2.5 mm (Product number: GAA-0068, manufactured by Hitachi High-Tech Science Corporation):
Weight of sample: 10±0.05 mg:
Measurement conditions: temperature at which heating is started: 30° C., temperature at which heating is ended: 170° C., heating rate: 10° C./min

A temperature at which an amount of heat absorption was maximized on a differential scanning calorimeter (DSC) curve obtained in accordance with the above-described measurement method was used as the melting point. Note that the heating was carried out only once per measurement and not carried out twice or more per measurement.

The polypropylene-based resin may have an average particle size of, for example, not less than 10 μm and not more than 1,000 μm, not less than 20 μm and not more than 900 μm, or not less than 30 μm and not more than 800 μm. In a case where the polypropylene-based resin has an average particle size of not less than 1 μm and not more than 1,000 μm, it is possible to produce a chlorinated polyvinyl chloride-based resin for obtaining a chlorinated polyvinyl chloride-based resin composition that is more excellent in processability and physical properties. In a case where the average particle size is not more than 1000 μm, it is easy to disperse the PP powder in the solvent. As a result, it is easy to produce a chlorinated polyvinyl chloride-based resin for obtaining a chlorinated polyvinyl chloride-based resin composition that is more excellent in processability, thermal stability, and physical properties.

Measurement of an average particle size of the polypropylene-based resin was carried out with the following device and under the following conditions.
Device: particle size distribution measuring device Microtrac MT3300EXII (manufactured by MicrotracBEL Corp.):
Measurement conditions: solvent: water, refractive index: 1.51, shape: nonsphere, measurement time: 10 seconds

Note that the “average particle size” described here represents a particle diameter at which a cumulative value reaches 50% in a particle size distribution obtained by laser diffractometry carried out with use of the above device.

A content of the polypropylene-based resin in the slurry may be not less than 0.060% by weight and not more than 0.359% by weight, not less than 0.060% by weight and not more than 0.279% by weight, or not less than 0.060% by weight and not more than 0.200% by weight. In a case where the content of the polypropylene-based resin is not less than 0.060% by weight and not more than 0.359% by weight, a reaction speed of the chlorination reaction of the polyvinyl chloride-based resin is not affected. As such, in a case where the content of the polypropylene-based resin is within this range, it is possible to produce a chlorinated polyvinyl chloride-based resin for obtaining a chlorinated polyvinyl chloride-based resin composition that is excellent in processability and physical properties.

Examples of commercially available powder of the polypropylene-based resin include: Hi-Wax NP055, Hi-Wax NP056, Hi-Wax NP105, and Hi-Wax NP805 manufactured by Mitsui Chemicals, Inc.; Biscol 550P manufactured by Sanyo Chemical Industries, Ltd.; and L-C502NC manufactured by CHUSEI OIL CO., LTD.

[Stirring Step]

In the stirring step, the slurry in the reactor is stirred and the reactor is subjected to vacuum deaeration and nitrogen replacement.

A speed of stirring the slurry is not particularly limited. For example, the number of rotations per minute may have a lower limit value of not less than 100 rpm, not less than 150 rpm, even not less than 400 rpm, or not less than 500 rpm. Regarding the speed of stirring the slurry, an upper limit value of the number of rotations per minute may be not more than 800 rpm, or not more than 700 rpm. Regarding the speed of stirring the slurry, in a case where the number of rotations per minute has a lower limit value of not less than 100 rpm and an upper limit value of not more than 800 rpm, the polyvinyl chloride-based resin and the powder of the polypropylene-based resin can be suitably dispersed in the solvent. This makes it possible to promote the chlorination reaction more suitably and to produce a chlorinated polyvinyl chloride-based resin for obtaining a chlorinated polyvinyl chloride-based resin composition that is more excellent in processability, thermal stability, and physical properties.

[Chlorine Supply Step]

In the chlorine supply step, chlorine is supplied to the slurry. This causes the polyvinyl chloride-based resin to be chlorinated.

The method of supplying the chlorine is not particularly limited, but can be, for example, a method in which chlorine-containing gas is supplied to the slurry.

The time over which the chlorine is supplied to the slurry is not particularly limited, but may be, for example, not less than 0.3 hours and not more than 12.0 hours, not less than 0.5 hours and not more than 7.0 hours, not less than 1.0 hours and not more than 3.5 hours, or not less than 2.0 hours and not more than 3.5 hours. In a case where the time over which the chlorine is supplied to the slurry is not less than 0.3 hours and not more than 12.0 hours, it is possible to sufficiently chlorinate the polyvinyl chloride-based resin contained in the slurry. That is, it is possible to produce a chlorinated polyvinyl chloride-based resin having a sufficient chlorine content. This makes it possible to produce a chlorinated polyvinyl chloride-based resin for obtaining a chlorinated polyvinyl chloride-based resin composition that is more excellent in processability, thermal stability, and physical properties.

A pressure inside the reactor during the chlorination reaction is not particularly limited, provided that the state in which the chlorine is supplied to the slurry can be maintained. The pressure inside the reactor during the chlorination reaction may be, for example, not less than 0 kPa and not more than 200 kPa, not less than 0 kPa and not more than 100 kPa, or not less than 0 kPa and not more than 50 kPa, in terms of gage pressure indicative of pressure relative to the atmospheric pressure being (zero). In a case where the pressure inside the reactor during the chlorination reaction is not less than 0 kPa and not more than 200 kPa in terms of gage pressure, it is possible to produce a chlorinated polyvinyl chloride-based resin for obtaining a chlorinated polyvinyl chloride-based resin composition that is more excellent in processability, thermal stability, and physical properties.

[Ultraviolet Irradiation Step]

In the ultraviolet step, the slurry to which the chlorine has been supplied is irradiated with ultraviolet light. This promotes chlorination of the polyvinyl chloride-based resin into the chlorinated polyvinyl chloride-based resin.

The method of ultraviolet irradiation is not particularly limited, but can be, for example, a method in which a light source such as a light emitting diode (LED) is used to apply ultraviolet light to the slurry to which the chlorine has been supplied.

When the chlorine has been supplied to the slurry for a predetermined period, it is assumed that sufficient chlorination of the polyvinyl chloride-based resin has been achieved, and the ultraviolet irradiation is ended to end the chlorination reaction. This allows a chlorinated polyvinyl chloride-based resin to be produced.

Note that the ultraviolet light to be applied has a peak wavelength that is not particularly limited but may be, for example, not less than 280 nm and not more than 420 nm. In a case where the ultraviolet light to be applied has a peak wavelength of not less than 280 nm and not more than 420 nm, it is possible to promote the chlorination reaction more suitably and to produce a chlorinated polyvinyl chloride-based resin for obtaining a chlorinated polyvinyl chloride-based resin composition that is more excellent in processability, thermal stability, and physical properties.

Note that although the ultraviolet supply step is carried out after the chlorine supply step in the above example, the ultraviolet supply step may be carried out simultaneously with the chlorine supply step in one or more embodiments. That is, it is possible to supply chlorine under irradiation with ultraviolet light. Further, in one or more embodiments, the chlorine supply step may be carried out after the ultraviolet supply step. Chlorination of the polyvinyl chloride-based resin can be achieved regardless of the order in which the chlorine supply step and the ultraviolet supply step are carried out.

(Chlorinated Polyvinyl Chloride-Based Resin)

The chlorinated polyvinyl chloride-based resin is produced by, in the chlorination step, (i) supplying the chlorine to the slurry containing the polyvinyl chloride-based resin and the powder of the polypropylene-based resin that has a viscosity average molecular weight of not less than 3,500 and (ii) irradiating the slurry with ultraviolet light to thereby chlorinate the polyvinyl chloride-based resin.

Note here that the chlorinated polyvinyl chloride-based resin is obtained by chlorination of the polyvinyl chloride-based resin, and the powder of the polypropylene-based resin having a viscosity average molecular weight of not less than 3,500 is mixed more uniformly throughout the chlorinated polyvinyl chloride-based resin, as compared with a case in which the powder of the polypropylene-based resin is simply added. It is thus possible to produce a resin composition of a chlorinated polyvinyl chloride-based resin for obtaining a chlorinated polyvinyl chloride-based resin composition that is more excellent in both processability and physical properties, as compared with a case in which the powder of the polypropylene-based resin having a viscosity average molecular weight of not less than 3,500 is simply added.

A chlorination degree of the chlorinated polyvinyl chloride-based resin may have a lower limit value of not less than 62%, or not less than 64%, and may have an upper limit value of not more than 70%. In a case where the chlorination degree of the chlorinated polyvinyl chloride-based resin has a lower limit value of not less than 62%, it is possible to obtain a chlorinated polyvinyl chloride-based resin for obtaining a chlorinated polyvinyl chloride-based resin composition that has a sufficient heat distortion temperature and an excellent thermal stability. In a case where the chlorination degree of the chlorinated polyvinyl chloride-based resin has an upper limit value of not less than 70%, it is possible to obtain a chlorinated polyvinyl chloride-based resin for obtaining a chlorinated polyvinyl chloride-based resin composition that has a melt viscosity not too high and is thus more excellent in processability, thermal stability, and physical properties.

[Water Rinsing and Drying Steps]

(Water Rinsing Step)

In the water rinsing step, nitrogen (e.g., nitrogen-containing gas) is supplied to the reactor after the ultraviolet irradiation step in the chlorination step, and unreacted chlorine in the chlorinated polyvinyl chloride-based resin is expelled by the nitrogen. Subsequently, in the water rinsing step, the chlorinated polyvinyl chloride-based resin is rinsed with water to remove residual hydrochloric acid.

(Drying Step)

In the drying step, the chlorinated polyvinyl chloride-based resin is taken out of the reactor and dried after the water rinsing step.

<Method for Producing Chlorinated Polyvinyl Chloride-Based Resin Composition>

A method for producing a chlorinated polyvinyl chloride-based resin composition in accordance with one or more embodiments includes an addition step.

[Addition Step]

In the addition step, an additive is added to the chlorinated polyvinyl chloride-based resin obtained by the chlorination step. More specifically, in the addition step, an additive is added to the chlorinated polyvinyl chloride-based resin which has been obtained by the ultraviolet step in the chlorination step described above and has been rinsed with water and dried, as needed, in the water rinsing step and the drying step. This yields a chlorinated polyvinyl chloride-based resin composition.

Note that in the addition step, the additive can be added to a resin consisting only of the chlorinated polyvinyl chloride-based resin. For example, in the addition step, the additive can be added to a resin consisting only of the chlorinated polyvinyl chloride-based resin and not containing a resin other than the chlorinated polyvinyl chloride-based resin, such as a resin obtained by mixing the chlorinated polyvinyl chloride-based resin and powder of a polypropylene-based resin.

In a case where powder of a polypropylene-based resin having a viscosity average molecular weight of not less than 3,500 is added to the slurry in advance and then the polyvinyl chloride-based resin is chlorinated, the powder of the polypropylene-based resin is mixed in the chlorinated polyvinyl chloride-based resin more uniformly as compared with a case in which the powder of the polypropylene-based resin is added after the chlorination step. Thus, the chlorinated polyvinyl chloride-based resin composition is excellent in processability and physical properties due to the fact that the powder of the polypropylene-based resin having a viscosity average molecular weight of not less than 3,500 is mixed more uniformly as compared with a case in which the powder of the polypropylene-based resin is simply added.

As such, by simply adding the additive to a resin consisting of the chlorinated polyvinyl chloride-based resin to which powder of a polypropylene-based resin or the like has not been added (mixed) after the chlorination step, it is possible to easily obtain a chlorinated polyvinyl chloride-based resin composition that has both good processability and good physical properties while retaining thermal stability.

[Additive]

The additive is added to the chlorinated polyvinyl chloride-based resin after the chlorination step. Examples of the additive include a lubricant, a thermal stabilizer, and an impact absorbing agent. The additive may include at least one selected from the group consisting of these examples.

(Lubricant)

The lubricant is used to improve processability of the chlorinated polyvinyl chloride-based resin composition. By adding the lubricant to the chlorinated polyvinyl chloride-based resin, it is possible to suitably subject the chlorinated polyvinyl chloride-based resin composition to extrusion.

The lubricant is not particularly limited, but can be, for example, polyethylene wax, polyethylene oxide, high molecular weight polyethylene wax, or the like. Polyethylene wax is preferable. In a case where the lubricant contains polyethylene wax, it is possible to further improve the processability of the chlorinated polyvinyl chloride-based resin composition.

The amount of the lubricant added may be not more than 2.8 parts by weight, not more than 2.7 parts by weight, not more than 2.6 parts by weight, or not more than 2.4 parts by weight relative to 100 parts by weight of the chlorinated polyvinyl chloride-based resin. In one or more embodiments, the above-described powder of the polypropylene-based resin is added to the slurry in advance and then the polyvinyl chloride-based resin is chlorinated. As such, the lubricant is added in a small amount, and a chlorinated polyvinyl chloride-based resin composition that is excellent in processability can be obtained without adding the lubricant in a large amount.

(Thermal Stabilizer)

The thermal stabilizer is used to improve thermal stability of the chlorinated polyvinyl chloride-based resin composition. By adding the thermal stabilizer to the chlorinated polyvinyl chloride-based resin, it is possible to prevent burning of the chlorinated polyvinyl chloride-based resin during the processing and a resultant decrease in productivity in extrusion.

The thermal stabilizer is not particularly limited, but can be, for example, a Sn-based stabilizer, a Ba—Zn-based stabilizer, a Ca—Zn-based stabilizer, a Pb-based stabilizer, a Mg—Al-based stabilizer, a hydrotalcite-based stabilizer, or the like. A Sn-based stabilizer such as methyltin mercapto is preferable. The thermal stabilizer containing the Sn-based stabilizer makes it possible to further improve thermal stability of the chlorinated polyvinyl chloride-based resin composition.

The amount of the thermal stabilizer added may be not more than 2.0 parts by weight, not more than 1.8 parts by weight, not more than 1.5 parts by weight, not more than 1.2 parts by weight, or not more than 1.0 part by weight relative to 100 parts by weight of the chlorinated polyvinyl chloride-based resin. In one or more embodiments, the above-described powder of the polypropylene-based resin is added to the slurry in advance and then the polyvinyl chloride-based resin is chlorinated. As such, the thermal stabilizer is added in a small amount, and a chlorinated polyvinyl chloride-based resin composition that is excellent in thermal stability can be obtained without adding the thermal stabilizer in a large amount.

(Impact Absorbing Agent)

The impact absorbing agent is intended to improve physical properties of the chlorinated polyvinyl chloride-based resin composition. Adding the impact absorbing agent to the chlorinated polyvinyl chloride-based resin makes it possible to improve physical properties such as tensile strength and impact resistance of the chlorinated polyvinyl chloride-based resin composition.

The impact absorbing agent is not particularly limited, but can be, for example, an acrylic rubber-based impact absorbing agent, a methyl methacrylate-butadiene-styrene-based polymer (MBS), a graft polymer, a chlorinated polyethylene (CPE), or the like. Examples of the graft polymer include: an acrylonitrile-butadiene-styrene-based polymer (ABS); and a graft polymer (MABS) obtained by a graft polymerization between butadiene or a styrene-butadiene rubber and methyl methacrylate-styrene-acrylonitrile. The impact absorbing agent may be an acrylic rubber-based impact absorbing agent, an MBS, and a CPE. In a case where the impact absorbing agent includes at least one selected from the group consisting of an acrylic rubber-based impact absorbing agent, a MBS, and a CPE, the physical properties of the chlorinated polyvinyl chloride-based resin composition can be further improved.

The amount of the impact absorbing agent added may be not more than 9 parts by weight, not more than 8 parts by weight, not more than 7 parts by weight, and not more than 6 parts by weight relative to 100 parts by weight of the chlorinated polyvinyl chloride-based resin. In one or more embodiments, the above-described powder of the polypropylene-based resin is added to the slurry in advance and then the polyvinyl chloride-based resin is chlorinated. As such, the impact absorbing agent is added in a small amount, and a chlorinated polyvinyl chloride-based resin composition that is excellent in physical properties can be obtained without adding the impact absorbing agent in a large amount.

One or more embodiments of the present invention are not limited to one or more embodiments, but can be altered by a skilled person in the art within the scope of the claims. One or more embodiments of the present invention also encompass, in their technical scope, any embodiments derived by combining technical means disclosed in differing embodiments.

All documents cited in the present disclosure are incorporated herein by reference.

### EXAMPLES

The following will provide Examples of one or more embodiments of the present invention to describe one or more embodiments of the present invention in further detail.

It should be understood that one or more embodiments of the present invention are not limited to Examples shown below and that details can be altered in various manners.

### Example 1

[Method for Producing Chlorinated Polyvinyl Chloride-Based Resin]

(Production of CPVC-1)

CPVC-1 was produced by the following production method.

First, 40 kg of pure water, 10 kg of a polyvinyl chloride-based resin, and 0.1 kg of powder of a polypropylene-based resin having a viscosity average molecular weight of 7,000 were introduced to a reactor, and the resultant mixture was stirred at a stirring speed of 600 rpm to obtain slurry.

The polyvinyl chloride-based resin used had been manufactured by KANEKA CORPORATION and had a K value of 66.4, an apparent density of 0.519 g/mL, and an average particle size of 171 μm. As the powder of the polypropylene-based resin, Hi-Wax NP056 manufactured by Mitsui Chemicals, Inc. and having a melting point of 127° C. and an average particle size of 171 μm was used.

The reactor was subjected to vacuum deaeration and nitrogen replacement. Then, while ultraviolet light having a peak wavelength of 365 nm was applied through an LED, chlorine gas was supplied to the slurry in the reactor for 2.5 hours so that the pressure inside the reactor was 20 kPa in terms of gage pressure. Thus, the polyvinyl chloride-based resin was chlorinated.

Then, ultraviolet irradiation using the LED was stopped, and nitrogen was supplied to the reactor to expel unreacted chlorine in the reactor by the nitrogen. The chlorinated polyvinyl chloride-based resin was rinsed with water to remove hydrochloric acid which was a by-product of the chlorination reaction of chlorinating the polyvinyl chloride-based resin. Subsequently, the chlorinated polyvinyl chloride-based resin was taken out of the reactor and dried. Thus obtained was CPVC-1, which is a chlorinated polyvinyl chloride-based resin in accordance with Example 1.

(Calculation of Chlorine Content)

A chlorine content of CPVC-1 was calculated on the basis of a neutralization titration value calculated by neutralizing an aqueous solution of hydrogen chloride (hydrochloric acid) produced by the chlorination reaction.

Specifically, 1 mol/L of an aqueous sodium hydroxide solution prepared by a factor of 1.000, that is, prepared to have an indicated concentration was used to carry out neutralization titration, and an amount of hydrogen chloride generated as a by-product in the system (reactor) was found by an equation below to calculate a chlorine content of CPVC-1.

Chlorine content (%)=35.5×(1+A/100)/(62.5+34.5×A/100)×100
A=(100−B)/B×0.625×C
B=Weight of polyvinyl chloride-based resin (kg)/(weight of polyvinyl chloride-based resin+weight of pure water) (kg)×100
C=Amount of aqueous sodium hydroxide solution dropped (mL)

As shown in Table 1 below, the obtained CPVC-1 had a chlorine content of 67% by weight.

Note that in Table 1 below, for convenience, the chlorinated polyvinyl chloride-based resin is indicated as “CPVC” and the polypropylene-based resin is indicated as “PP”. Further, the component resin at the time of adding the additive (described later) is indicated as “component resin at the time of addition”. Similarly, the viscosity average molecular weight of the polypropylene-based resin contained in the slurry at the time of the chlorination reaction is indicated as “molecular weight of PP at the time of chlorination”. The melting point of the polypropylene-based resin contained in the slurry at the time of the chlorination reaction is indicated as “melting point of PP at the time of chlorination”. The average particle size of the polypropylene-based resin contained in the slurry at the time of the chlorination reaction is indicated as “average particle size of PP at the time of chlorination”. The viscosity average molecular weight of the polypropylene-based resin contained in the resin at the time of adding the additive is indicated as “molecular weight of PP at the time of addition”. The term “parts by weight” in Table 1 means parts by weight of a resin and an additive based on 100 parts by weight of the resin at the time of adding an additive.

[Evaluations]

To 100 parts by weight of CPVC-1, 2.4 parts by weight of a lubricant, 1.0 part by weight of a thermal stabilizer, and 6 parts by weight of an acrylic rubber-based impact absorbing agent were added as an additive to obtain a CPVC-1 resin composition. The thermal stabilizer used was methyltin mercapto, which is a Sn-based stabilizer. The CPVC-1 resin composition was evaluated in terms of processability, thermal stability, and physical properties.

(Evaluation of Processability) With use of a Labo-plastomill roller mixer R60 manufactured by Toyo Seiki Seisaku-sho, Ltd., processability of the CPVC-1 resin composition was evaluated.

Specifically, a chamber of the above roller mixer was filled with 65 g of the CPVC-1 resin composition in a state where the chamber was stably heated to 170° C. Subsequently, the roller was rotated at a rotation speed of 50 rpm to knead the CPVC-1 resin composition for not less than 7 minutes, and a value of torque applied to the roller was measured.

When the value of the torque leveled off and the variation in the value of the torque stabilized, the value of the torque was read as “kneading torque” for evaluating the processability of the CPVC-1 resin composition.

The kneading torque is proportional to the melting viscosity of the CPVC-1 resin composition. The lower the numerical value of the kneading torque, the less likely the generation of shear heat. As such, it was determined that the lower the numerical value of the kneading torque, the better the processability of the CPVC-1 resin composition.

As shown in Table 1 below, the CPVC-1 resin composition had kneading torque as low as 4.87 kgf·m and thus was found to be excellent in processability.

(Evaluation of Thermal Stability)

With use of a Labo-plastomill roller mixer R60 manufactured by Toyo Seiki Seisaku-sho, Ltd., thermal stability of the CPVC-1 resin composition was evaluated.

Specifically, in a state where the chamber of the above roller mixer was stably heated to 190° C., the chamber was filled with 65 g of the CPVC-1 resin composition. While the rotor was rotated at a rotation speed of 50 rpm to knead the CPVC-1 resin composition, a value of torque was measured.

Time (duration) taken from when the value of the torque leveled off and stabilized once to when the value of the torque started to increase was read as “time until a torque increase” for evaluating thermal stability of the CPVC-1 resin composition.

The time until a torque increase is proportional to the dynamic thermal stability of the CPVC-1 resin composition. It was determined that the longer the time until a torque increase, the better the thermal stability of the CPVC-1 resin composition.

As shown in Table 1 below, the CPVC-1 resin composition was found to be excellent in thermal stability because the time until a torque increase was as long as 12.9 minutes.

(Evaluation of Physical Properties)

With use of a hydraulic molding press manufactured by Shinto Metal Industries, Ltd. (single-action compression molding machine SF-37H-2C) and a tension testing machine manufactured by Shimadzu Corporation (Shimadzu precision universal test machine Autograph AG-X), physical properties of the CPVC-1 resin composition were evaluated.

Specifically, first, the CPVC-1 resin composition was kneaded for 6 minutes with use of an 8-inch roller having a roller temperature of 190° C. Then, a sheet of the CPVC-1 resin composition was prepared in a thickness of 0.7 mm to 0.9 mm.

Then, the obtained sheet of the CPVC-1 resin composition was cut into a certain size (18 cm×9 cm). The cut sheets of the CPVC-1 resin composition were stacked together and pressed with use of the above hydraulic molding press for 10 minutes at 200° C. under a pressure condition of not less than 1 MPa and not more than 8 MPa.

After the pressing, the CPVC-1 resin composition was cooled and taken out as a pressed plate having a specimen thickness of 3 mm. Then, the pressed plate was cut to prepare a Type-1 specimen (ASTM D638), that is, a specimen of a so-called ASTM1 dumbbell specimen.

With use of the above tension testing machine, a tensile test was carried out in accordance with ASTM D638 with respect to the obtained specimen under the following measurement conditions: a test temperature of 23° C., a chuck-to-chuck distance of 110 mm, a distance between marked lines of 50 mm, and a tensile speed of 5 mm/min. Thus measured was a yield point stress of the CPVC-1 resin composition.

The yield point stress is proportional to the physical properties of the CPVC-1 resin composition. It was determined that the higher the numerical value of the yield point stress, the better the physical properties of the CPVC-1 resin composition.

As shown in Table 1 below, the CPVC-1 resin composition was found to be excellent in physical properties because the yield point stress was as high as 51.1 MPa.

### Example 2

[Method for Producing Chlorinated Polyvinyl Chloride-Based Resin]

In Example 2, a chlorinated polyvinyl chloride-based resin was produced with use of powder of a polypropylene-based resin having a viscosity average molecular weight of 7,300 instead of powder of a polypropylene-based resin having a viscosity average molecular weight of 7,000. As the powder of the polypropylene-based resin having a viscosity average molecular weight of 7,300, Hi-Wax NP055 manufactured by Mitsui Chemicals, Inc. and having a melting point of 147° C. and an average particle size of 111 μm was used. Apart from this change, a production method (operation) similar to that of Example 1 was employed to produce a chlorinated polyvinyl chloride-based resin in Example 2. Thus obtained was CPVC-2.

As shown in Table 1 below, the obtained CPVC-2 had a chlorine content of 67% by weight.

[Evaluations]

In Example 2, an additive was added to CPVC-2, instead of CPVC-1 in Example 1, to obtain a CPVC-2 resin composition. Apart from this change, evaluations of processability, thermal stability, and physical properties of the CPVC-2 resin composition were carried out in a similar manner to the CPVC-1 resin composition in Example 1.

As shown in Table 1 below, the CPVC-2 resin composition had a lower kneading torque (4.84 kgf·m), a long time until a torque increase (12.7 minutes), and a high yield point stress (51.1 MPa). It was thus found that the CPVC-2 resin composition was excellent in all of processability, thermal stability, and physical properties and superior in processability to the CPVC-1 resin composition in Example 1.

### Example 3

[Method for Producing Chlorinated Polyvinyl Chloride-Based Resin]

In Example 3, a chlorinated polyvinyl chloride-based resin was produced with use of powder of a polypropylene-based resin having a viscosity average molecular weight of 11,000 instead of powder of a polypropylene-based resin having a viscosity average molecular weight of 7,000. As the powder of the polypropylene-based resin having a viscosity average molecular weight of 11,000, Hi-Wax NP105 manufactured by Mitsui Chemicals, Inc. and having a melting point of 150° C. and an average particle size of 106 μm was used. Apart from this change, a production method similar to that of Example 1 was employed to produce a chlorinated polyvinyl chloride-based resin in Example 3. Thus obtained was CPVC-3.

As shown in Table 1 below, the obtained CPVC-3 had a chlorine content of 67% by weight.

[Evaluations]

In Example 3, an additive was added to CPVC-3, instead of CPVC-1 in Example 1, to obtain a CPVC-3 resin composition. Apart from this change, evaluations of processability, thermal stability, and physical properties of the CPVC-3 resin composition were carried out in a similar manner to the CPVC-1 resin composition in Example 1.

As shown in Table 1 below, the CPVC-3 resin composition had a particularly low kneading torque (4.83 kgf·m), a particularly long time until a torque increase (13.6 minutes), and a high yield point stress (51.2 MPa). It was thus found that the CPVC-3 resin composition was superior in all of processability, thermal stability, and physical properties to the CPVC-1 resin composition in Example 1.

### Example 4

[Method for Producing Chlorinated Polyvinyl Chloride-Based Resin]

In Example 4, a chlorinated polyvinyl chloride-based resin was produced with use of powder of a polypropylene-based resin having a viscosity average molecular weight of 21,000 instead of powder of a polypropylene-based resin having a viscosity average molecular weight of 7,000. As the powder of the polypropylene-based resin having a viscosity average molecular weight of 21,000, Hi-Wax NP505 manufactured by Mitsui Chemicals, Inc. and having a melting point of 153° C. and an average particle size of 124 μm was used. Apart from this change, a production method similar to that of Example 1 was employed to produce a chlorinated polyvinyl chloride-based resin in Example 4. Thus obtained was CPVC-4.

As shown in Table 1 below, the obtained CPVC-4 had a chlorine content of 67% by weight.

[Evaluations]

In Example 4, an additive was added to CPVC-4, instead of CPVC-1 in Example 1, to obtain a CPVC-4 resin composition. Apart from this change, evaluations of processability, thermal stability, and physical properties of the CPVC-4 resin composition were carried out in a similar manner to the CPVC-1 resin composition in Example 1.

As shown in Table 1 below, the CPVC-4 resin composition had a lower kneading torque (4.85 kgf·m), a longer time until a torque increase (13.1 minutes), and a particularly high yield point stress (51.5 MPa). It was thus found that the CPVC-4 resin composition was superior in all of processability, thermal stability, and physical properties to the CPVC-1 resin composition in Example 1.

### Example 5

[Method for Producing Chlorinated Polyvinyl Chloride-Based Resin]

In Example 5, a chlorinated polyvinyl chloride-based resin was produced with use of powder of a polypropylene-based resin having a viscosity average molecular weight of 30,000 instead of powder of a polypropylene-based resin having a viscosity average molecular weight of 7,000. As the powder of the polypropylene-based resin having a viscosity average molecular weight of Hi-Wax NP805 manufactured by Mitsui Chemicals, Inc. and having a melting point of 155° C. and an average particle size of 131 μm was used. Apart from this change, a production method similar to that of Example 1 was employed to produce a chlorinated polyvinyl chloride-based resin in Example 5. Thus obtained was CPVC-5.

As shown in Table 1 below, the obtained CPVC-5 had a chlorine content of 67% by weight.

[Evaluations]

In Example 5, an additive was added to CPVC-5, instead of CPVC-1 in Example 1, to obtain a CPVC-5 resin composition. Apart from this change, evaluations of processability, thermal stability, and physical properties of the CPVC-5 resin composition were carried out in a similar manner to the CPVC-1 resin composition in Example 1.

As shown in Table 1 below, the CPVC-5 resin composition had a low kneading torque (4.90 kgf·m), a long time until a torque increase (12.4 minutes), and a particularly high yield point stress (51.7 MPa). It was thus found that the CPVC-5 resin composition was excellent in all of processability, thermal stability, and physical properties and superior in physical properties to the CPVC-1 resin composition in Example 1.

### Example 6

[Method for Producing Chlorinated Polyvinyl Chloride-Based Resin]

In Example 6, a chlorinated polyvinyl chloride-based resin was produced with use of powder of a polypropylene-based resin having a viscosity average molecular weight of 4,000 instead of powder of a polypropylene-based resin having a viscosity average molecular weight of 7,000. As the powder of the polypropylene-based resin having a viscosity average molecular weight of 4,000, Biscol 550P manufactured by Sanyo Chemical Industries, Ltd. and having a melting point of 148° C. and an average particle size of 87 μm was used. Apart from this change, a production method similar to that of Example 1 was employed to produce a chlorinated polyvinyl chloride-based resin in Example 6. Thus obtained was CPVC-6.

As shown in Table 1 below, the obtained CPVC-6 had a chlorine content of 67% by weight.

[Evaluations]

In Example 6, an additive was added to CPVC-6, instead of CPVC-1 in Example 1, to obtain a CPVC-6 resin composition. Apart from this change, evaluations of processability, thermal stability, and physical properties of the CPVC-6 resin composition were carried out in a similar manner to the CPVC-1 resin composition in Example 1.

As shown in Table 1 below, the CPVC-6 resin composition had a low kneading torque (4.86 kgf·m), a long time until a torque increase (12.8 minutes), and a high yield point stress (51.3 MPa). It was thus found that the CPVC-6 resin composition was excellent in all of processability, thermal stability, and physical properties and superior in physical properties to the CPVC-1 resin composition in Example 1.

### Example 7

[Method for Producing Chlorinated Polyvinyl Chloride-Based Resin]

In Example 7, a chlorinated polyvinyl chloride-based resin was produced with use of powder of a polypropylene-based resin having a viscosity average molecular weight of 3,500 instead of powder of a polypropylene-based resin having a viscosity average molecular weight of 7,000. As the powder of the polypropylene-based resin having a viscosity average molecular weight of 3,500, L-C502NC manufactured by CHUSEI OIL CO., LTD and having a melting point of 149° C. and an average particle size of 79 μm was used. Apart from this change, a production method similar to that of Example 1 was employed to produce a chlorinated polyvinyl chloride-based resin in Example 7. Thus obtained was CPVC-7.

As shown in Table 1 below, the obtained CPVC-7 had a chlorine content of 67% by weight.

[Evaluations]

In Example 6, an additive was added to CPVC-7, instead of CPVC-1 in Example 1, to obtain a CPVC-7 resin composition. Apart from this change, evaluations of processability, thermal stability, and physical properties of the CPVC-7 resin composition were carried out in a similar manner to the CPVC-1 resin composition in Example 1.

As shown in Table 1 below, the CPVC-7 resin composition had a low kneading torque (4.86 kgf·m), a long time until a torque increase (13.1 minutes), and a high yield point stress (51.4 MPa). It was thus found that the CPVC-7 resin composition was excellent in all of processability, thermal stability, and physical properties and superior in physical properties to the CPVC-1 resin composition in Example 1.

### Comparative Example 1

[Method for Producing Chlorinated Polyvinyl Chloride-Based Resin]

In Comparative Example 1, chlorine gas was supplied to slurry containing neither powder of a polypropylene-based resin having a viscosity average molecular weight of 7,000 nor Hi-Wax NP056 manufactured by Mitsui Chemicals, Inc., and the slurry was irradiated with ultraviolet light to chlorinate a polyvinyl chloride-based resin. Apart from thus not using powder of a polypropylene-based resin at the time of chlorination, a production method similar to that of Example 1 was employed to produce a chlorinated polyvinyl chloride-based resin. Thus obtained was CPVC-8.

The obtained CPVC-8 had a chlorine content of 67% by weight.

[Evaluations]

In Comparative Example 1, an additive was added to CPVC-8, instead of CPVC-1 in Example 1, to obtain a CPVC-8 resin composition-1. Apart from this change, evaluations of processability, thermal stability, and physical properties of the CPVC-8 resin composition-1 were carried out in a similar manner to the CPVC-1 resin composition in Example 1.

As shown in Table 1 below, the CPVC-8 resin composition-1 had a high yield point stress (51.7 MPa) but had a high kneading torque (5.00 kgf·m) and a short time until a torque increase (10 minutes). It was thus found that the CPVC-8 resin composition-1 was excellent in physical properties but was not excellent, that is, was inferior (poor), in processability and thermal stability.

### Reference Example 1

[Method for Producing Chlorinated Polyvinyl Chloride-Based Resin]

In Reference Example 1, CPVC-8, which is a chlorinated polyvinyl chloride-based resin, was produced in a similar manner to Comparative Example 1.

[Evaluations]

In Reference Example 1, 2.9 parts by weight of a lubricant and 2.0 parts by weight of a thermal stabilizer, not 2.4 parts by weight of a lubricant and 1.0 part by weight of a thermal stabilizer, were added to 100 parts by weight of CPVC-8. Apart from this change, an operation similar to that of the Comparative Example was employed to obtain a CPVC-8 resin composition-2.

Evaluations of processability, thermal stability, and physical properties of the CPVC-8 resin composition-2 were carried out in a similar manner to the Comparative Example.

As shown in Table 1 below, the CPVC-8 resin composition-2 had a low kneading torque (4.89 kgf·m) and a long-lasting thermal stability (13.8 minutes). Further, the CPVC-8 resin composition-2 had a high yield point stress (51.1 MPa).

It was thus found that the CPVC-8 resin composition-2 was excellent in all of processability, thermal stability, and physical properties. However, the CPVC-8 resin composition-2 required large amounts of additives (the lubricant and the thermal stabilizer) in order to exhibit the above properties.

Further, the CPVC-8 resin composition-2 was also found to have improved processability and thermal stability by the increased amounts of the lubricant and the thermal stabilizer added.

This indicates that, unlike the CPVC-8 resin composition-1 in accordance with Comparative Example 1, the resin compositions in accordance with Examples 1 to 7 each exhibited excellent processability and thermal stability even though the amount in which the additive such as a lubricant and a thermal stabilizer was added was not large.

### Comparative Example 2

[Method for Producing Chlorinated Polyvinyl Chloride-Based Resin]

In Comparative Example 2, CPVC-8, which is a chlorinated polyvinyl chloride-based resin, was produced in a similar manner to Comparative Example 1.

[Evaluations]

In Comparative Example 2, an additive was added not to 100 parts by weight of CPVC-8 but to 100 parts by weight of a mixed resin containing 99 parts by weight of CPVC-8 and 1 part by weight of powder of a polypropylene-based resin having a viscosity average molecular weight of 11,000. As the powder of the polypropylene-based resin having a viscosity average molecular weight of 11,000, Hi-Wax NP105 manufactured by Mitsui Chemicals, Inc. was used.

That is, in Comparative Example 2, the additive was added to 100 parts by weight of a mixed resin in which 1 part by weight out of the 100 parts by weight of CPVC-8 was replaced with the powder of the polypropylene-based resin having a viscosity average molecular weight of 11,000. Apart from this change, an operation similar to that of Comparative Example 1 was employed to obtain a CPVC-8 resin composition-3.

Evaluations of processability, thermal stability, and physical properties of the CPVC-8 resin composition-3 were carried out in a similar manner to Comparative Example 1.

As shown in Table 1 below, the CPVC-8 resin composition-3 had a low kneading torque (4.67 kgf·m) and a long-lasting thermal stability (19.1 minutes). However, the CPVC-8 resin composition-3 had a low yield point stress (50.3 MPa).

It was thus found that the CPVC-8 resin composition-3 was excellent in processability and thermal stability but was not excellent, that is, was inferior, in physical properties.

It was found that, in contrast, excellent processability, thermal stability, and physical properties are exhibited by a resin composition, such as those in Examples 1 to 7, that is obtained with use of a chlorinated polyvinyl chloride-based resin obtained by (i) supplying chlorine to slurry containing powder of a polypropylene-based resin having a viscosity average molecular weight of not less than 3,500 and (ii) irradiating the slurry with ultraviolet light.

### Comparative Example 3

[Method for Producing Chlorinated Polyvinyl Chloride-Based Resin]

In Comparative Example 3, CPVC-8, which is a chlorinated polyvinyl chloride-based resin, was produced in a similar manner to Comparative Example 1.

[Evaluations]

In Comparative Example 3, an additive was added not to 100 parts by weight of CPVC-8 but to 100 parts by weight of a mixed resin containing 99 parts by weight of CPVC-8 and 1 part by weight of powder of a polypropylene-based resin having a viscosity average molecular weight of 21,000. As the powder of the polypropylene-based resin having a viscosity average molecular weight of 21,000, Hi-Wax NP505 manufactured by Mitsui Chemicals, Inc. was used.

That is, in Comparative Example 3, the additive was added to 100 parts by weight of a mixed resin in which 1 part by weight out of the 100 parts by weight of CPVC-8 was replaced with the powder of the polypropylene-based resin having a viscosity average molecular weight of 21,000. Apart from this change, an operation similar to that of Comparative Example 1 was employed to obtain a CPVC-8 resin composition-4.

In other words, in Comparative Example 3, a CPVC-8 resin composition-4 was obtained by carrying out an operation similar to that of Comparative Example 2, except for using powder of a polypropylene-based resin having a viscosity average molecular weight of 21,000 instead of powder of a polypropylene-based resin having a viscosity average molecular weight of 11,000.

Evaluations of processability, thermal stability, and physical properties of the CPVC-8 resin composition-4 were carried out in a similar manner to the Comparative Example.

As shown in Table 1 below, the CPVC-8 resin composition-4 had a low kneading torque (4.73 kgf·m) and a long time until a torque increase (19 minutes). However, the CPVC-8 resin composition-4 had a low yield point stress (50.4 MPa).

It was thus found that the CPVC-8 resin composition-4 was excellent in processability and physical properties, even though the powder of the polypropylene-based resin having a viscosity average molecular weight of 21,000, which would allow physical properties of a resin composition to be particularly high, was added.

TABLE 1

| | | | Example 1 | Example 2 | Example 3 | Example 4 | Example 5 | Example 6 |
|---|---|---|---|---|---|---|---|---|
| Resin | | Component | CPVC-1 | CPVC-2 | CPVC-3 | CPVC-4 | CPVC-5 | CPVC-6 |
| | | resin at the | | | | | | |
| | | time of | | | | | | |
| | | addition | | | | | | |
| | | Parts by | 100 | 100 | 100 | 100 | 100 | 100 |
| | | weight | | | | | | |
| | | Molecular | 7,000 | 7,300 | 11,000 | 21,000 | 30,000 | 4,000 |
| | | weight of PP | | | | | | |
| | | at the time | | | | | | |
| | | of | | | | | | |
| | | chlorination | | | | | | |
| | | Molecular | — | — | — | — | — | — |
| | | weight of PP | | | | | | |
| | | at the time | | | | | | |
| | | of addition | | | | | | |
| Melting point of PP at | | ° C. | 127 | 147 | 150 | 153 | 155 | 148 |
| the time of chlorination | | | | | | | | |
| Average particle size of | | μm | 171 | 111 | 103 | 124 | 131 | 87 |
| PP at the time of | | | | | | | | |
| chlorination | | | | | | | | |
| Chlorine content | | % by weight | 67 | 67 | 67 | 67 | 67 | 67 |
| Additive | Lubricant | Parts by | 2.4 | 2.4 | 2.4 | 2.4 | 2.4 | 2.4 |
| | | weight | | | | | | |
| | Thermal | Parts by | 1 | 1 | 1 | 1 | 1 | 1 |
| | stabilizer | weight | | | | | | |
| | Impact | Parts by | 6 | 6 | 6 | 6 | 6 | 6 |
| | absorbing | weight | | | | | | |
| | agent | | | | | | | |
| Evaluation | Kneading | kgf · m | 4.87 | 4.84 | 4.83 | 4.85 | 4.90 | 4.86 |
| | torque | | | | | | | |
| | Time until | Minute | 12.9 | 12.7 | 13.6 | 13.1 | 12.4 | 12.8 |
| | torque | | | | | | | |
| | increase | | | | | | | |
| | Yield point | MPa | 51.1 | 51.1 | 51.2 | 51.5 | 51.7 | 51.3 |
| | stress | | | | | | | |

| | | | | Comparative | Reference | Comparative | Comparative |
|---|---|---|---|---|---|---|---|
| | | | Example 7 | Example 1 | Example 1 | Example 2 | Example 3 |
| Resin | | Component | CPVC-7 | CPVC-8 | CPVC-8 | CPVC-8 + | CPVC-8 + |
| | | resin at the | | | | PP | PP |
| | | time of | | | | | |
| | | addition | | | | | |
| | | Parts by | 100 | 100 | 100 | 99 + 1 | 99 + 1 |
| | | weight | | | | | |
| | | Molecular | 3,500 | — | — | — | — |
| | | weight of PP | | | | | |
| | | at the time | | | | | |
| | | of | | | | | |
| | | chlorination | | | | | |
| | | Molecular | — | — | — | 11,000 | 21,000 |
| | | weight of PP | | | | | |
| | | at the time | | | | | |
| | | of addition | | | | | |
| Melting point of PP at | | ° C. | 149 | — | — | — | — |
| the time of chlorination | | | | | | | |
| Average particle size of | | μm | 79 | — | — | — | — |
| PP at the time of | | | | | | | |
| chlorination | | | | | | | |
| Chlorine content | | % by weight | 67 | 67 | 67 | 67 | 67 |
| Additive | Lubricant | Parts by | 2.4 | 2.4 | 2.9 | 2.4 | 2.4 |
| | | weight | | | | | |
| | Thermal | Parts by | 1 | 1 | 2 | 1 | 1 |
| | stabilizer | weight | | | | | |
| | Impact | Parts by | 6 | 6 | 6 | 6 | 6 |
| | absorbing | weight | | | | | |
| | agent | | | | | | |
| Evaluation | Kneading | kgf · m | 4.86 | 5.00 | 4.89 | 4.67 | 4.73 |
| | torque | | | | | | |
| | Time until | Minute | 13.1 | 10.0 | 13.8 | 19.1 | 19.0 |
| | torque | | | | | | |
| | increase | | | | | | |
| | Yield point | MPa | 51.4 | 51.7 | 51.1 | 50.3 | 50.4 |
| | stress | | | | | | |

<Supplementary Note>

One or more embodiments of the present invention include the following.

<1> A method for producing a chlorinated polyvinyl chloride-based resin, including a chlorination step of (i) supplying chlorine to slurry containing a polyvinyl chloride-based resin and powder of a polypropylene-based resin that has a viscosity average molecular weight of not less than 3,500 and (ii) irradiating the slurry with ultraviolet light to thereby chlorinate the polyvinyl chloride-based resin.

<2> The method as set forth in <1>, wherein the polypropylene-based resin has a viscosity average molecular weight of not less than 4,000.

<3> The method as set forth in <1>, wherein the polypropylene-based resin has a viscosity average molecular weight of not less than 5,000.

<4> The method as set forth in <1>, wherein the polypropylene-based resin has a viscosity average molecular weight of not less than 7,000.

<5> The method as set forth in <1>, wherein the polypropylene-based resin has a viscosity average molecular weight of not less than 10,000.

<6> The method as set forth in any one of <1> to <5>, wherein the polypropylene-based resin has a viscosity average molecular weight of not more than 30,000.

<7> The method as set forth in any one of <1> to <5>, wherein the polypropylene-based resin has a viscosity average molecular weight of not more than 25,000.

<8> The method as set forth in any one of <1> to <5>, wherein the polypropylene-based resin has a viscosity average molecular weight of not more than 21,000.

<9> The method as set forth in any one of <1> to <8>, wherein the polypropylene-based resin has an average particle size of not less than 10 μm and not more than 1,000 μm.

<10> The method as set forth in any one of <1> to <9>, wherein the polypropylene-based resin has a melting point of not lower than 100° C. and not higher than 170° C.

<11> A method for producing a chlorinated polyvinyl chloride-based resin composition, including an addition step of adding an additive to the chlorinated polyvinyl chloride-based resin obtained by the method recited in any one of <1> to <10>,
the additive including at least one selected from the group consisting of not more than 2.8 parts by weight of a lubricant, not more than 2.0 parts by weight of a thermal stabilizer, and not more than 9 parts by weight of an impact absorbing agent, relative to 100 parts by weight of the chlorinated polyvinyl chloride-based resin.

<12> The method as set forth in <11>, wherein the thermal stabilizer is contained in an amount of not more than 1.8 parts by weight.

<13> The method as set forth in <11> or <12>, wherein the impact absorbing agent is contained in an amount of not more than 8 parts by weight.

<14> The method as set forth in any one of <11> to <13>, wherein the addition step includes adding the additive to a resin consisting only of the chlorinated polyvinyl chloride-based resin.

One or more embodiments of the present invention can be used in a heat-resistant pipe, a heat-resistant joint, a heat-resistant valve, a heat-resistant sheet, and the like.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A method for producing a chlorinated polyvinyl chloride-based resin, comprising,
a chlorination step of:
(i) supplying chlorine to a slurry containing a polyvinyl chloride-based resin and powder of a polypropylene-based resin that has a viscosity average molecular weight of not less than 3,500; and
(ii) irradiating the slurry with ultraviolet light thereby chlorinating the polyvinyl chloride-based resin.

2. The method as set forth in claim 1, wherein the polypropylene-based resin has the viscosity average molecular weight of not less than 4,000.

3. The method as set forth in claim 1, wherein the polypropylene-based resin has the viscosity average molecular weight of not less than 5,000.

4. The method as set forth in claim 1, wherein the polypropylene-based resin has the viscosity average molecular weight of not less than 7,000.

5. The method as set forth in claim 1, wherein the polypropylene-based resin has the viscosity average molecular weight of not less than 10,000.

6. The method as set forth in claim 1, wherein the polypropylene-based resin has the viscosity average molecular weight of not more than 30,000.

7. The method as set forth in claim 1, wherein the polypropylene-based resin has the viscosity average molecular weight of not more than 25,000.

8. The method as set forth in claim 1, wherein the polypropylene-based resin has the viscosity average molecular weight of not more than 21,000.

9. The method as set forth in claim 1, wherein the polypropylene-based resin has an average particle size of not less than 10 μm and not more than 1,000 μm.

10. The method as set forth in claim 1, wherein the polypropylene-based resin has a melting point of not lower than 100° C. and not higher than 170° C.

11. A method for producing a chlorinated polyvinyl chloride-based resin composition, comprising an addition step of adding an additive to the chlorinated polyvinyl chloride-based resin obtained by the method recited in claim 1,
wherein the additive includes at least one selected from the group consisting of not more than 2.8 parts by weight of a lubricant, not more than 2.0 parts by weight of a thermal stabilizer, and not more than 9 parts by weight of an impact absorbing agent, relative to 100 parts by weight of the chlorinated polyvinyl chloride-based resin.

12. The method as set forth in claim 11, wherein the thermal stabilizer is contained in an amount of not more than 1.8 parts by weight.

13. The method as set forth in claim 11, wherein the impact absorbing agent is contained in an amount of not more than 8 parts by weight.

14. The method as set forth in claim 11, wherein the addition step includes adding the additive to a resin consisting only of the chlorinated polyvinyl chloride-based resin.
